(19) United States
(12) Patent Application Publication
(10) Pub. No.: US 2003/0050820 A1
(43) Pub. Date: Mar. 13, 2003

(54) Method and apparatus for managing a user group list for a business process managed using a state machine

(75) Inventors: Mitchell Adam Cohen, Yorktown Heights, NY (US); Richard Thomas Goodwin, New York, NY (US); Titania Mary Gupta, Hawthorne, NY (US); Laurent David Hasson, New York, NY (US); John Scott Houston, Hopewell Junction, NY (US); Jianren Li, Valhalla, NY (US); John Joseph Rofrano, Mahopac, NY (US)

Correspondence Address: Ryan, Mason & Lewis, LLP, 1300 Post Road, Suite 205, Fairfield, CT, 06430, US

(73) Assignee: International Business Machines Corporation, Armonk, NY

(21) Appl. No.: 09/951,029

(22) Filed: Sep. 11, 2001

(51) Int. Cl. G06F 17/60

(52) U.S. Cl. 705/9

(57) ABSTRACT

A method and apparatus are disclosed for maintaining membership lists associated with given states of a state machine. The present invention uses a state machine to represent a business process. The state machine includes a plurality of states, and at least one state includes an entry action that is executed upon entering the state. A user group list can be accessed and processed using the entry action. When an object enters a state, the corresponding entry action may be executed. The entry action will obtain the membership group name from the corresponding state definition. If the field is not null, then the business process manager queries the membership subsystem to obtain a list of individuals who belong to that membership group name for the organization which owns the object. Only those users are notified that the object is awaiting approval and are therefore designated as the preferred approvers for this object. A state table can be maintained indicating all objects that are awaiting action by one of the members designated on the preferred user list.

### CROSS REFERENCE TO RELATED APPLICATIONS

The present invention is related to United States Patent Application entitled “Method and Apparatus for Automatic Transitioning Between States in a State Machine That Manages a Business Process,” (Attorney Docket Number SOM920010005US1), United States Patent Application entitled “Method and Apparatus for Managing The Versioning of Business Objects Using a State Machine,” (Attorney Docket Number SOM920010006US1), United States Patent Application entitled “Method and Apparatus for Creating and Managing Complex Business Processes,” (Attorney Docket Number SOM920010007US1), United States Patent Application entitled “Method and Apparatus for Monitoring Execution of a Business Process Managed Using a State Machine,” (Attorney Docket Number SOM920010008US1) and United States Patent Application entitled “Method and Apparatus for Managing and Displaying User Authorizations for a Business Process Managed Using a State Machine,” (Attorney Docket Number SOM920010009US1), filed contemporaneously herewith, assigned to the assignee of the present invention and incorporated by reference herein.

### FIELD OF THE INVENTION

The present invention relates generally to techniques for representing business processes as state machines, and more particularly, to a method and apparatus for managing membership lists for various groups of users for a business process that is managed using a state machine.

### BACKGROUND OF THE INVENTION

Business processes are often used to manage various trading mechanisms, such as auctions, contracts, and requests for quotes (RFQs). At the same time, much of business revolves around making decisions. Typically, these decisions are made by authorized individuals acting on behalf of their organizations, applying a variety of rules or guidelines. The actual decision-making logic may be simple or extremely complex depending upon the needs of the business and the decision being made. However, the demands on decision-makers are rapidly increasing along with the pace of business. This leaves the decision-makers overloaded, many times with trivial decisions, thus decreasing the amount of time that they have to focus on more important decisions. It has been found that business processes can be represented using a state machine. State machines provide a way to control the set of events and actions that may be performed by authorized users throughout the life cycle of a business object.

Among other benefits, state machines provide a means for automating some decision-making. For example, if the number of levels of approval in a business process can be configured in such a way that it appeared to dynamically change at run time to match the requirements of the user organization, then many organizations would be able to share the same business process. If this same mechanism also allowed automatic decision-making support for the more routine decisions, then the workload of the decision-makers could be eased to allow them to focus their attention on the more difficult matters. Overall, there would be increased flexibility without increased expense or complexity.

For certain tasks in a business process, such as obtaining an approval for a transaction, there is often a difference between individuals who are authorized to perform an operation and individuals who are actually requested to perform that operation. For example, this distinction is very important when you need to notify those who are requested to actually perform an approval action and do not want to notify the potentially much larger group of people who have authority to perform the approval action.

As an example, consider the differences between a company having 100 employees and a company having 1000 employees. Assume that in both cases, all managers are allowed to approve most transactions. When an item is ready for approval, if the system sends notifications to all people who are allowed to approve the transaction, then all managers will be sent notifications. While this may be acceptable in a smaller organization, it becomes increasingly impractical as companies grow in size. The majority of notified individuals have no interest in most of these transactions. Furthermore, when a manager attempts to display a list of items awaiting approval, every transaction which he has authority to approve will be included, thus impairing the ability to find the items in which the manager is really interested.

A number of techniques have been proposed or suggested for identifying a certain set of individuals associated with a particular event. When the event is obtaining an approval for a transaction, the appropriate approvers have been identified using a list of authorized approvers for a particular transaction. A similar function may be accomplished using guards within transitions between states of a state machine, as defined within the Unified Modeling Language (UML) syntax, to provide access control. However, each of these approaches merely define who is allowed to perform the action. A need exists, however, for a method and apparatus that separately identifies those individuals who are authorized to perform an operation (referred to herein as the authorized actors) from those individuals who are actually requested to perform that operation (referred to herein as the “preferred” actors).

### SUMMARY OF THE INVENTION

Generally, a method and apparatus are disclosed for maintaining membership lists associated with given states of a state machine. The present invention uses a state machine to represent a business process. The state machine includes a plurality of states, and at least one state includes an entry action that is executed upon entering the state. The present invention expands the concept of what can be done from within an entry action. Specifically, the present invention provides for a user group list to be accessed and processed using the entry action.

According to one aspect of the invention, when an object enters a state, the corresponding entry action may be executed. The entry action will obtain the membership group name from the corresponding state definition. If the field is not null, then the business process manager queries the membership subsystem to obtain a list of individuals who belong to that membership group name for the organization which owns the object. Only those users are notified that the object is awaiting approval and are therefore designated as the preferred approvers for this object. In one embodiment, a state table is maintained indicating all objects that are awaiting action by one of the members designated on the preferred user list.

The present invention thus expands the capabilities of an entry action, and provides a method to distinguish between those individuals that are authorized to perform an operation (referred to herein as the authorized actors) from those individuals that are actually requested to perform that operation (referred to herein as the “preferred” actors). By placing the user list maintenance logic in an entry action, the logic is more easily and consistently defined and maintained.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary conventional state machine having two states for managing a business process;

FIG. 2 illustrates an exemplary conventional approval process where an order is submitted for approval;

FIG. 3 illustrates an approval process where an order is submitted for approval, in accordance with the present invention;

FIG. 4 is a sample table from an exemplary flow state dictionary table incorporating features of the present invention;

FIG. 5 is a sample table from an approval table incorporating features of the present invention;

FIG. 6 is a flow chart describing an exemplary approval table maintenance process; and

FIG. 7 illustrates an exemplary network environment in which the present invention can operate.

### DETAILED DESCRIPTION OF PREFERRED EMBODIMENTS

The present invention provides a method and apparatus for maintaining membership lists associated with given states of a state machine. Specifically, the present invention separately identifies those individuals who are authorized to perform an operation (referred to herein as the authorized actors) from those individuals who are actually requested to perform that operation (referred to herein as the “preferred” actors).

### State Machine Terminology

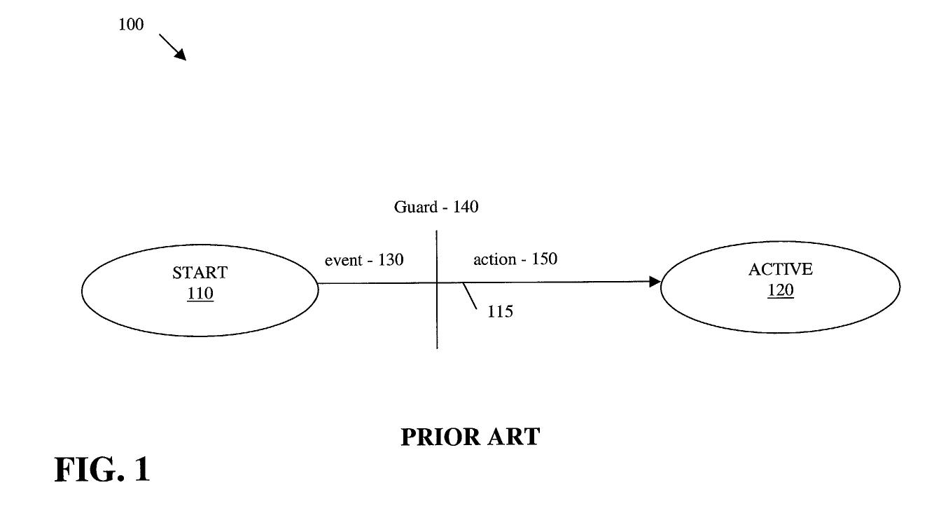

Business processes can be represented using a state machine. State machines provide a way to control the set of events and actions that may be performed throughout the life cycle of a business object. The Unified Modeling Language (UML) provides a standardized syntax for describing state machines. FIG. 1 illustrates an exemplary state machine 100 having two states 110, 120 with a single transition 115 leading from the Start state 110 to the Active state 120. The transition 115 is composed of three parts. First, there is an event 130 that defines what may cause this transition 115 to be attempted. Second, one or more guards 140 determine whether or not the transition 115 may be taken based upon some predefined criteria, such as the authority of the user or certain values associated with the business object. Finally, the action 150 provides a means for identifying logic that may act upon, or on behalf of, the object being managed by the state machine 100. Thus, if the transition 115 is allowed according to the guards 140, then the action 150 is performed and the object moves into the Active state 120. The various components of a transition 115 can be expressed using the notation “event [guard] action.”

For a more detailed discussion of techniques for managing business processes using a state machine, see, for example, U.S. patent application Ser. No. 09/818,719, filed Mar. 27, 2001, entitled “E-Market Architecture for Supporting Multiple Roles and Reconfigurable Business Processes,” August-Wilhelm Scheer, Aris—Business Process Modeling, Springer Verlag, 1999 or Peter Muth et al., Enterprise-Wide Workflow Management Based on State and Activity Charts, in A. Dogac, L. Kalinichenko, T. Ozsu, A. Sheth (Editors), Workflow Management Systems and Interoperability, Springer Verlag, 1998, each incorporated by reference herein.

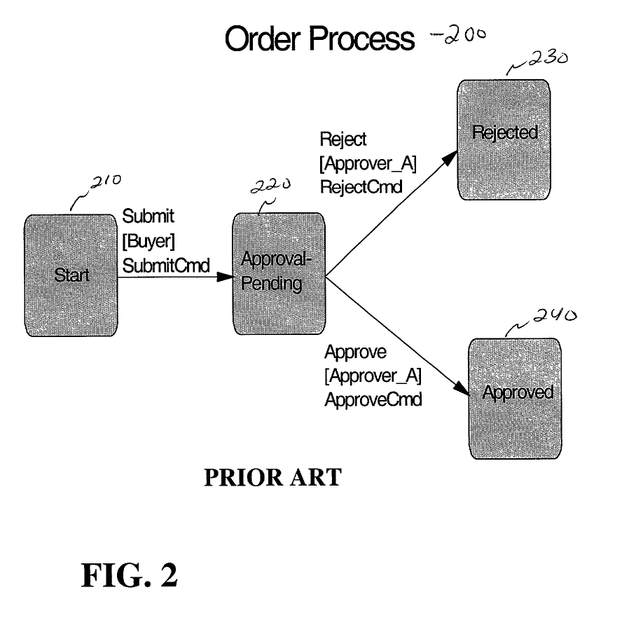

FIG. 2 illustrates an exemplary conventional approval process 200, where an order is submitted for approval. When the order is submitted by an authorized user, perhaps by clicking a submit button on a web page (not shown) from a browser, the order moves from a start state 210 into an approval pending state 220 where another authorized user is expected to make the decision to approve or reject the order. More specifically, when a user with “buyer” authority submits an order for approval, the order moves to the approval-pending state 220. Once the decision is made by a user with “Approver_A” authority, then the order moves into either the rejected state 230 or the approved state 240. In other words, the user who triggers either the Approve or Reject events must pass the Approver_A guard definition. In this case, the Approver_A guard is an access control guard which defines who may invoke the approve or reject transitions.

Within the UML syntax, an entry action can be associated with a state. An entry action is logic which may execute when an object enters a state, and it may perform a variety of operations, but is typically used to clean up from transitions or set up for the newly entered state. The present invention makes use of the entry action to support the approval and notification processes. As discussed hereinafter, the present invention expands the concept of what can be done from within an entry action.

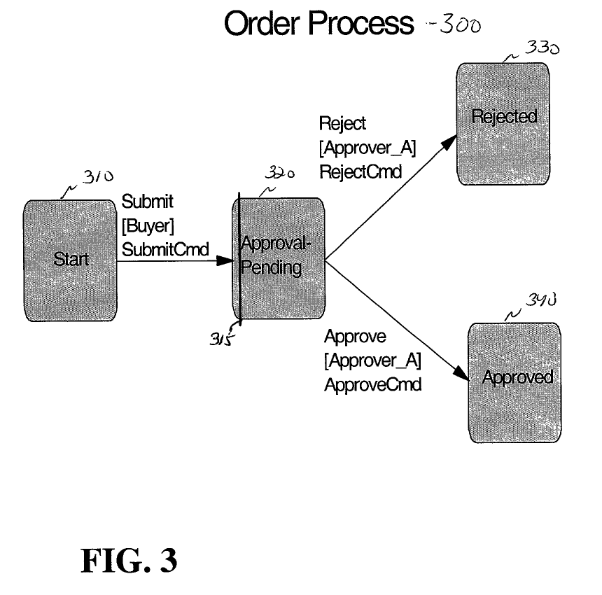

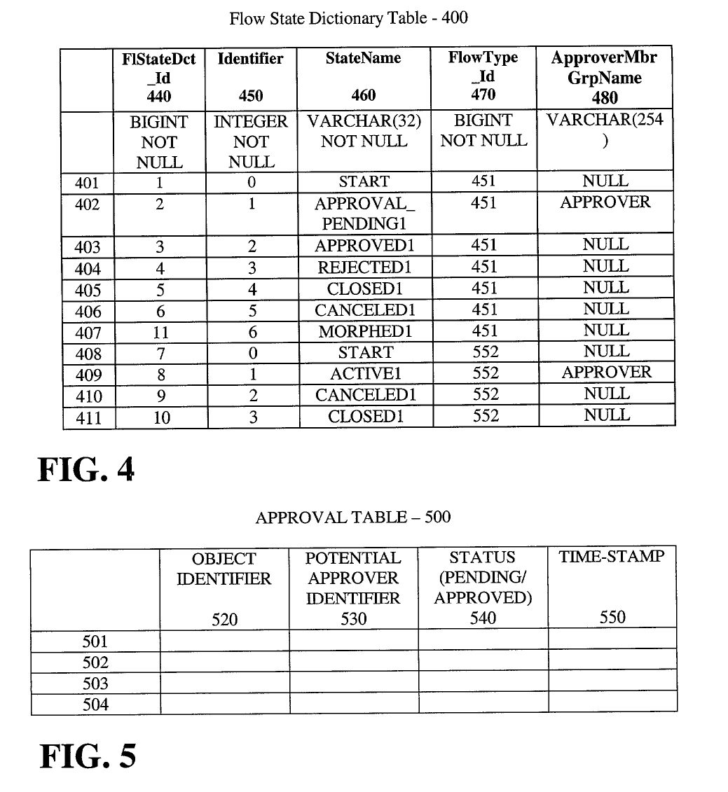

FIG. 3 illustrates an exemplary approval process 300 in accordance with the present invention, extending the example of FIG. 2. When an object enters the Approval-Pending state 320, an entry action 315 may be executed, as shown in FIG. 3. The entry action 315, when processed by the business process manager, will obtain the membership group name from the state definition contained in the corresponding record of the flow state dictionary table 400, discussed below in conjunction with FIG. 4. If the field is not null, then the business process manager queries the membership subsystem to obtain a list of individuals who belong to that membership group name for the organization which owns the object. Only those users are notified that the object is awaiting approval and are therefore designated as the preferred approvers for this object. As with the conventional state machine shown in FIG. 3, any user with “Approver_A” authority can move the order into the rejected state 330 or the approved state 340 (whether or not this user is a “preferred approver” in accordance with the present invention).

FIG. 4 is a sample table from an exemplary flow state dictionary table 400 incorporating features of the present invention. Generally, the flow state dictionary table 400 stores information about each state in a state machine. The flow state dictionary table 400 includes a plurality of records, such as records 401-411, each associated with a different state in the state machine. For each state identified in field 440, the flow state dictionary table 400 stores, among other things, an identifier in field 450 that uniquely identifies the state with a Flow Type, the name of the states in field 460, the flow type to which the state belongs in field 470, and the names of any defined membership list(s) in field 480. A value of NULL indicates that there is no membership list with respect to this state.

FIG. 5 is a sample table from an approval table 500 incorporating features of the present invention. Generally, the approval table 500 can be used assist in searching for objects awaiting approval by a particular user. Whenever an object enters the approval state 320, a row is created for each user in the approval request membership group associated with the state.

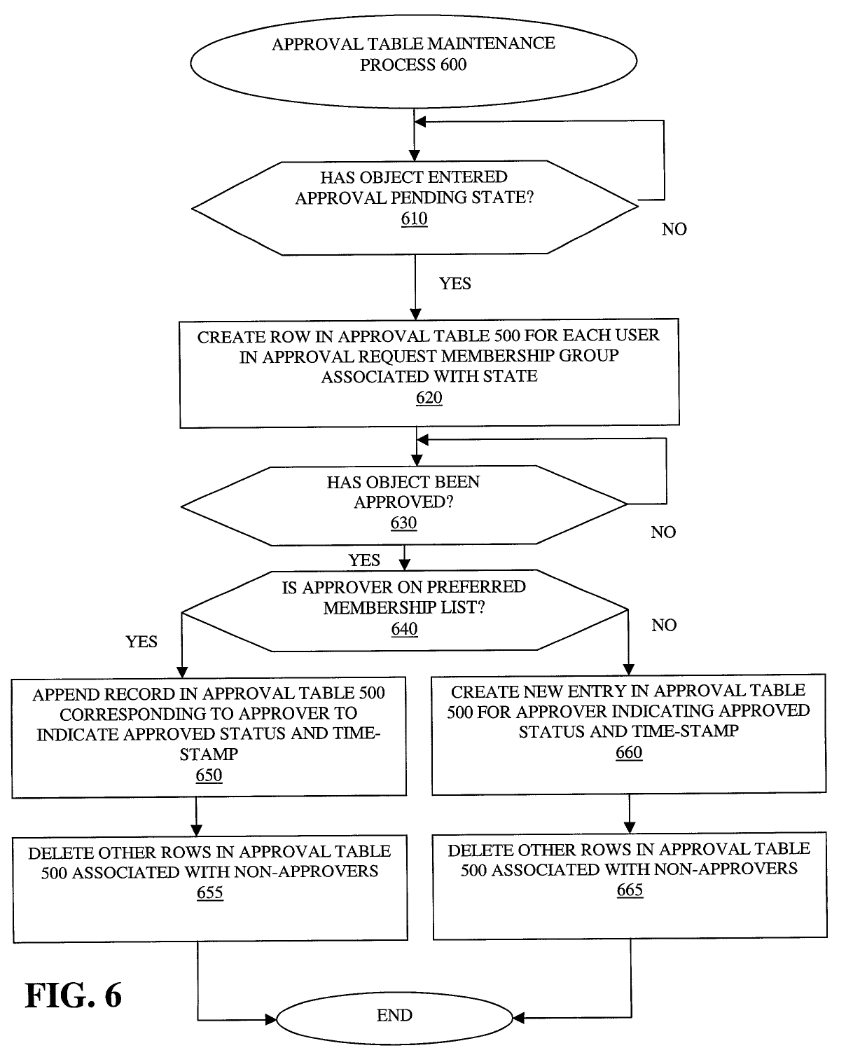

FIG. 6 is a flow chart describing an exemplary approval table maintenance process 600. As shown in FIG. 6, the approval table maintenance process 600 is initiated during step 610 when an object enters the approval pending state (or some other state having a preferred member list associated with its entry action). Once an object is determined during step 610 to enter the approval pending state 320, the approval table maintenance process 600 creates a row during step 620 in the approval table 500 for each user designated in the approval request membership group associated with the approval pending state 320.

A test is performed during step 630 to determine if the object has been approved. Once it is determined during step 630 that the object has been approved, then a further test is performed during step 640 to determine if the approver is on the preferred membership list. If it is determined during step 640 that the approver is on the preferred membership list, then the record in the approval table 500 corresponding to approver is appended during step 650 to indicate the approved status, together with a time-stamp. Thereafter, other rows in the approval table 500 associated with non-approvers are deleted during step 655.

If, however, it is determined during step 640 that the approver is not on the preferred membership list, then a new entry in the approval table 500 is created during step 660 for the approver indicating the approved status, together with a time-stamp. Thereafter, other rows in the approval table 500 associated with non-approvers are deleted during step 665. Program control then terminates. In this manner, the approval table 500 is maintained to have an accurate listing of those transactions that are currently pending approval, which may be easily reviewed by the preferred approvers. This record keeping is primarily for tracking and auditing and to avoid multiple attempts to approve the same request.

As has been illustrated, the ability to separate the access control from the preferred approver list provides significant power and creates a far more adaptable basis for implementing approvals. By using this invention, objects awaiting input or approval from users do not notify any extra users who are not necessarily interested nor involved with the objects' processes. If there is a need for someone outside of the preferred list to act upon the item, then they can still do so since the access control guards allow them to invoke the transition.

The concept of associating names with states provides other benefits as well. One additional use derived from this approach is that it allows a single business process to support organizations with somewhat different approval requirements. For example, Organization A may require three levels of approval while Organization B requires only a single level of approval. But the business processes that they follow are otherwise identical (the same states and transitions). By using the business process for the three levels of approval as required by Organization A, Organization B can still use that exact same business process. In order to do that, Organization B would define an approver membership group that corresponds with the first approval-pending state, but either not define the additional membership groups, or leave them empty.

The state machines may be defined in such a way that when the entry actions determine that a membership group does not exist or is empty, then the state may be skipped. This will happen for each approval state encountered which fits these criteria. In this way, system resources may be conserved without impacting the users, and the processes do not have to be rewritten or copied. Instead, the business processes become very adaptable and useable even for organizations which are structured very differently. In addition, the present invention provides support for a general notification process. A membership group name may be used to specify which members of the organization should be notified when an object enters a particular state.

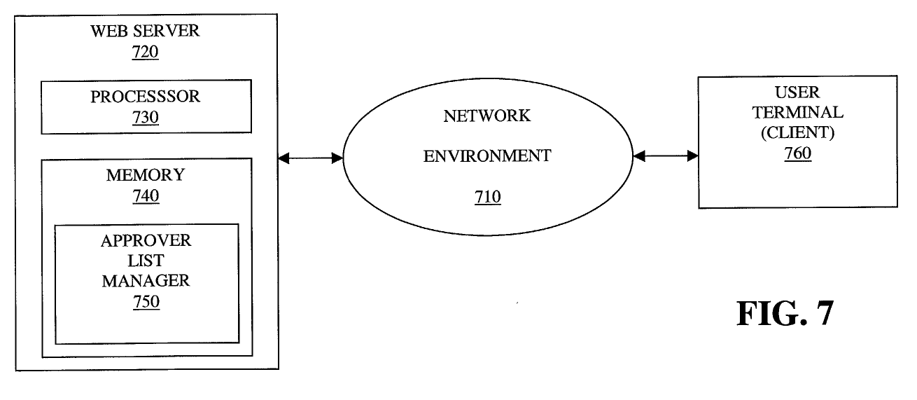

FIG. 7 illustrates an exemplary network environment 710 in which the present invention can operate. As shown in FIG. 7, a web server 720 communicates over a network 710 with a user terminal 760. For example, the user 760 may submit an order for goods or services to the web server 720. The process that determines whether a given user has sufficient authorization to perform a certain task may be managed in accordance with an approver list manager 750 incorporating features of the present invention, as discussed above. The network 710 can be any wired or wireless network for transferring information, such as a data network or a telephone network.

Memory 740 will configure the processor 730 to implement the methods, steps, and functions disclosed herein. The memory 740 could be distributed or local and the processor 730 could be distributed or singular. The memory 740 could be implemented as an electrical, magnetic or optical memory, or any combination of these or other types of storage devices. The term “memory” should be construed broadly enough to encompass any information able to be read from or written to an address in the addressable space accessed by processor 730. With this definition, information on a network 710 is still within memory 740 of the web server 720 because the processor 730 can retrieve the information from the network 710.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for managing a business process using a state machine, said state machine having a plurality of states, at least one of said states including an entry action, said entry action including logic executed upon entering said state, said method comprising the step of:
providing logic in said entry action, said logic causing an action to be performed using a user list.

2. The method of claim 1, wherein said action is notifying users on said user list that an object has entered said corresponding state to be sent to one or more users on a list.

3. The method of claim 1, wherein said action creates a record of an object entering said corresponding state for each user on said list.

4. The method of claim 3, further comprising the step of updating said record associated with an actor when said object transitions out of said state.

5. The method of claim 3, further comprising the step of removing any records associated with a non-actor when said object is transitioned out of said state by an actor.

6. A method for managing a business process using a state machine, said state machine having a plurality of states, at least one of said states including an entry action, said entry action including logic executed upon entering said state, said method comprising the steps of:
evaluating said entry action upon entering said state, said entry action including a user list and a designated action to perform with said user list; and
performing said designated action with said user list.

7. The method of claim 5, wherein said action is notifying users on said user list that an object has entered said corresponding state to be sent to one or more users on a list.

8. The method of claim 5, wherein said action creates a record of an object entering said corresponding state for each user on said list.

9. The method of claim 8, further comprising the step of updating said record associated with an actor when said object transitions out of said state.

10. The method of claim 8, further comprising the step of removing any records associated with a non-actor when said object is transitioned out of said state by an actor.

11. A system for managing a business process using a state machine, said state machine having a plurality of states, at least one of said states including an entry action, said entry action including logic executed upon entering said state, comprising:
a memory that stores computer-readable code; and
a processor operatively coupled to said memory, said processor configured to implement said computer-readable code, said computer-readable code configured to:
provide logic in said entry action, said logic causing an action to be performed using a user list.

12. The system of claim 11, wherein said action is notifying users on said user list that an object has entered said corresponding state to be sent to one or more users on a list.

13. The system of claim 11, wherein said action creates a record of an object entering said corresponding state for each user on said list.

14. The system of claim 13, further comprising the step of updating said record associated with an actor when said object transitions out of said state.

15. The system of claim 13, further comprising the step of removing any records associated with a non-actor when said object is transitioned out of said state by an actor.

16. A system for managing a business process using a state machine, said state machine having a plurality of states, at least one of said states including an entry action, said entry action including logic executed upon entering said state, comprising:
a memory that stores computer-readable code; and
a processor operatively coupled to said memory, said processor configured to implement said computer-readable code, said computer-readable code configured to:
evaluate said entry action upon entering said state, said entry action including a user list and a designated action to perform with said user list; and
perform said designated action with said user list.

17. The system of claim 16, wherein said action is notifying users on said user list that an object has entered said corresponding state to be sent to one or more users on a list.

18. The system of claim 16, wherein said action creates a record of an object entering said corresponding state for each user on said list.

19. The system of claim 18, further comprising the step of updating said record associated with an actor when said object transitions out of said state.

20. The system of claim 18, further comprising the step of removing any records associated with a non-actor when said object is transitioned out of said state by an actor.

21. An article of manufacture for managing a business process using a state machine, said state machine having a plurality of states, at least one of said states including an entry action, said entry action including logic executed upon entering said state, comprising:
a computer readable medium having computer readable code means embodied thereon, said computer readable program code means comprising:
a step to provide logic in said entry action, said logic causing an action to be performed using a user list.

22. An article of manufacture for managing a business process using a state machine, said state machine having a plurality of states, at least one of said states including an entry action, said entry action including logic executed upon entering said state, comprising:
a computer readable medium having computer readable code means embodied thereon, said computer readable program code means comprising:
a step to evaluate said entry action upon entering said state, said entry action including a user list and a designated action to perform with said user list; and
a step to perform said designated action with said user list.
